(19) United States
(12) Patent Application Publication
(10) Pub. No.: US 2014/0005914 A1
(43) Pub. Date: Jan. 2, 2014

(54) METHOD FOR AUTOMATICALLY STOPPING AN INTERNAL COMBUSTION ENGINE OF A MOTOR VEHICLE

(71) Applicant: DAIMLER AG, Stuttgart (DE)

(72) Inventor: Werner Bernzen, Ehningen (DE)

(73) Assignee: DAIMLER AG, Stuttgart (DE)

(21) Appl. No.: 13/944,724

(22) Filed: Jul. 17, 2013

Related U.S. Application Data
(63) Continuation-in-part of application No. PCT/EP2011/006162, filed on Dec. 8, 2011.

(30) Foreign Application Priority Data
Jan. 19, 2011 (DE) 10 2011 009 001.0

(51) Int. Cl. F02D 45/00

(52) U.S. Cl. CPC F02D 45/00
USPC 701/112

(57) ABSTRACT

In a method for stopping an internal combustion engine of a motor vehicle, stop prevention conditions are established for preventing automatic stopping of the internal combustion engine even when all stop conditions are me but one of the stop prevention conditions is not met. One of the stop prevention conditions is for example an activated risk status (GS), the risk status (GS) being activated when an acute indication (AI) is present. After the acute indication (AI) has ended, the risk status (GS) remains activated until a safety indication (SI) is present, so that, due to the internal combustion engine remaining switched on, maneuverability of the motor vehicle is maintained at least until the safety indication (SI) is recognized

This is a continuation-in-part application of pending international patent application PCT/EP 2011/006162 filed 8 Dec. 2011 and claiming the priority of German Patent Application 10 2011 009 001.0 filed 19 Jan. 2011.

### BACKGROUND OF THE INVENTION

The invention relates to a method for automatically stopping an internal combustion engine of a motor vehicle when certain conditions are met.

It is known that recent motor vehicles have so-called stop-start systems by means of which an internal combustion engine of the motor vehicle is automatically stopped and restarted after the engine has been started by a driver during a driving cycle. The automatic stopping generally takes place when the internal combustion engine is idling and no torque of the internal combustion engine is needed for propulsion of the motor vehicle or for an auxiliary drive. The automatic starting generally takes place when a torque request is made on the internal combustion engine, either by the driver via an accelerator pedal or by an auxiliary drive such as an air conditioner. Methods for automatically stopping and/or starting an internal combustion engine by means of a stop-start system therefore include these types of stop conditions and start conditions. In addition, methods of this type also include stop prevention conditions. Such stop prevention conditions prevent an automatic stop of the internal combustion engine even though the other stop conditions are met. One example of a stop prevention condition is the condition of an open hood; i.e., an automatic stop of the internal combustion engine is prevented for safety reasons under the condition that the hood of the motor vehicle is open. In this regard see DE 102 11 466 01, for example.

JP 2001-032734 A describes a method for automatically stopping an internal combustion engine of a motor vehicle, in which automatic stopping of the internal combustion engine is prevented under the condition that locking of the wheels of the motor vehicle by an antilocking system, for example, has been detected. This prevention of stopping is active as long as the locking is present. The aim of this stop prevention condition is to avoid a situation in which locked wheels of the motor vehicle, i.e., wheels having a wheel speed of zero, are misinterpreted by the stop-start system as a vehicle standstill. A vehicle standstill is a situation in which no drive torque is required, and thus, a situation in which a stop-start system preferably stops the internal combustion engine.

EP 1 647 707 A1 which relates to the same species, discloses a method for automatically stopping an internal combustion engine wherein, after an acute indication has ended, a risk status remains activated until a further condition is met in addition to the ending of the acute indication.

In the mentioned method there is the problem that safety aspects, in particular the aspect of a collision risk, is/are not taken into account. The object of the present invention, therefore, is to provide a method for automatically stopping an internal combustion engine of a motor vehicle, which allows improved performance of the motor vehicle in order to avoid collisions.

### SUMMARY OF THE INVENTION

In a method for stopping an internal combustion engine of a motor vehicle, stop prevention conditions are established for preventing automatic stopping of the internal combustion engine even when all stop conditions are met but one of the stop prevention conditions is not met. One of the stop prevention conditions is for example an activated risk status (GS), the risk status (GS) being activated when an acute indication (AI) is present. After the acute indication (AI) has ended, the risk status (GS) remains activated until a safety indication (SI) is present, so that, due to the internal combustion engine remaining switched on, maneuverability of the motor vehicle is maintained at least until the safety indication (SI) is recognized.

Examples of the stop conditions include the following:
a coolant temperature of the internal combustion engine which is above a threshold,
a vehicle speed which is below a threshold,
a battery voltage which is above a threshold,
an activation of a brake, wherein an activation rate is above a threshold.

A further condition for automatically stopping the internal combustion engine is an absence of a stop prevention condition. A stop prevention condition is present when one of the following criteria, listed by way of example, is met:
a hood is open,
a vehicle door is open,
a parking maneuver is underway.

When at least one of the criteria for the stop prevention condition is present, an automatic stop of the internal combustion engine is prevented according to the method, even if all of the above-mentioned stop conditions are met.

In addition to the above examples, according to the invention at least one of the criteria for the stop prevention condition is an active risk status.

The risk status is understood to mean status information which indicates whether or not a risk is present according to predefined assessment criteria. The risk status may assume two values: an active risk status indicates a recognition of the risk, and an inactive or deactivated risk status indicates absence of the risk. The risk is essentially a situation in which there is an increased probability that the motor vehicle will collide with another motor vehicle or with an obstruction, or that the motor vehicle will tip or roll over. From the start until the end of the risk situation, it is desirable that the drive force of the motor vehicle remains dynamically available. If the internal combustion engine were automatically shut off during the risk situation, the build-up of a required drive torque would be delayed by an automatic starting operation. During the risk situation, a driver of the motor vehicle as well as an automatic safety system of the motor vehicle may request a drive torque in order to avoid a collision or to change a motion of the vehicle. The aim of the invention is to ensure that such a torque request in the motor vehicle having a stop-start system is followed by a rapid build-up of torque of the internal combustion engine.

According to the invention, the risk situation is divided into two successive phases, namely, an acute phase and a latency phase. Both phases are defined according to suitable criteria. The acute phase is based on acute criteria, which indicate a very high probability of the presence of the risk, The latency phase is based on latency criteria, which indicate the presence of the risk with a lower probability than the probability for the acute phase, or which indicate with a very high probability a lower risk.

In the case of meeting the acute criteria, according to the invention an acute indication is activated. The acute indication is understood to mean status information which indicates whether or not an acute phase is present according to the acute criteria. When the acute criteria are not met, i.e., when no acute phase is present, the acute indication is deactivated; i.e., an acute indication is not present. When the acute criteria are met, i.e., when an acute phase is present, the acute indication is activated; i.e., an acute indication is present.

The risk status is activated when an acute indication is activated, and the risk status remains activated as long as the acute indication is active, Immediately after an acute phase, i.e., immediately after a deactivation of the acute indication, the risk status remains activated, since according to the invention at least one further condition besides the deactivation of the acute indication must be met in order to deactivate the risk status. This further condition is an activation of a safety indication. The safety indication is understood to mean status information which indicates whether a conclusion may be made with a very high probability, according to suitable safety criteria, that a risk is no longer present. The safety criteria include not only the negated acute criteria, but also the additional criteria. Presence of the safety indication means an active safety indication and an absence of the risk.

A first advantageous refinement of the method provides that the safety indication is present under the minimum prerequisite that the acute indication has ended and a predetermined period of time has subsequently elapsed. Immediately after the acute indication has ended, there is a certain probability that a state which caused the acute indication is once again occurring. This probability decreases after a certain period of time after the acute indication has ended. Therefore, for safety reasons it is meaningful to activate the safety indication only after the predetermined period of time after the deactivation of the acute indication. The predetermined period of time is meaningfully in the range of a few seconds, preferably 5 to 10 seconds.

Another advantageous refinement of the method provides that the safety indication is present under the minimum prerequisite that the acute indication has ended, and the motor vehicle has subsequently covered a specified distance. If the specified distance has been covered without the acute indication having been reactivated, it may be assumed with a high level of probability that the risk has permanently ended. A meaningful specified distance is in the range of a few hundred meters to a few kilometers.

The start of the acute phase, i.e., a change from a normal operating mode or normal operating environment of the motor vehicle to a hazardous operating mode or a hazardous operating environment of the motor vehicle, is advantageously deduced from measurable variables, wherein risk conditions are established as a function of the measurable variables, and these risk conditions are monitored. If at least one risk condition is present, the acute phase is present; i.e., the acute indication is activated. Different types of risks having particular risk conditions may be based on different types of acute indications. The acute indication is activated when one of the risk conditions is met. In addition, each type of risk advantageously has specific criteria for the activation of a

[symbol]

Another advantageous refinement of the method accordingly provides that one type of acute indication is an acceleration indication, the acceleration indication being activated under the minimum prerequisite that a magnitude of a vehicle acceleration in one direction is greater than a first acceleration limit value, and the safety indication is present under the minimum prerequisite that at least the magnitude of the vehicle acceleration in one direction is less than a second acceleration limit value, the second acceleration limit value being less than or equal to the first acceleration limit value. A risk situation is thus recognized based on an exceedance of the first acceleration limit value of the motor vehicle, A meaningful first acceleration limit value is 5 to 10 m/s², particularly advantageously 8 m/s². An end of the risk situation is recognized not when the acceleration value is less than the first acceleration limit value, but, rather, only when the acceleration value is less than the second acceleration limit value, for example 3 m/s².

Another advantageous refinement provides that a further type of acute indication is a transverse acceleration indication, the transverse acceleration indication being activated under the minimum prerequisite that a magnitude of a vehicle transverse acceleration is greater than a first transverse acceleration limit value, and the safety indication is present under the minimum prerequisite that the magnitude of the vehicle transverse acceleration is less than a second transverse acceleration limit value, the second transverse acceleration limit value being less than or equal to the first transverse acceleration limit value. The transverse acceleration is understood to mean an acceleration of the motor vehicle transverse to the direction of travel.

A detection of a transverse acceleration of the motor vehicle which is greater than the first transverse acceleration limit value indicates a skidding or drifting motion of the motor vehicle, and is therefore a clear indication of a risk situation. A permanent end of this type of risk situation may be assumed with a particularly high level of probability when, after the acceleration value is less than the first transverse acceleration limit value, the acceleration value is also less than a second transverse acceleration limit value, the second transverse acceleration limit value being less than the first transverse acceleration limit value.

Another advantageous refinement provides that a further type of acute indication is a control indication, the control indication being activated under the minimum prerequisite that understeering or oversteering of the motor vehicle has been recognized, and the safety indication is present under the minimum prerequisite that no understeering and no oversteering of the motor vehicle is recognized for a predetermined period of time and/or

[symbol]

Another advantageous refinement provides that a further type of acute indication is to a steering indication, the steering indication being activated under the minimum prerequisite that a rapid steering movement at a high speed has been recognized, and the safety indication is activated under the minimum prerequisite that no rapid steering movement is recognized for a specified period of time. The steering indication is advantageously activated when the steering speed is less than a first limit value for a steering speed, and the safety indication is not activated until the steering speed is less than a second limit value of the steering speed.

Another advantageous refinement provides that a further type of acute indication is a target braking indication, the target braking indication being activated under the minimum prerequisite that radar-assisted target braking is carried out, Information concerning the presence of target braking may be obtained from appropriate known safety systems.

Another advantageous refinement provides that a further type of acute indication is a braking indication, the braking indication being activated under the minimum prerequisite that full braking and/or automatic braking is/are carried out. In the case of full braking or automatic braking, safety is increased in that, during the full braking or the automatic braking and for a certain period of time or distance afterward, a stop of the internal combustion engine does not occur on account of the stop prevention condition being activated, so that the vehicle maintains optimal maneuverability.

Another advantageous refinement provides that a further type of acute indication is a collision indication, the collision indication being activated under the minimum prerequisite that a collision risk is recognized. The collision risk may be a collision risk in the direction of travel, or may be a lateral collision risk. A collision risk may be recognized, for example, by a radar-assisted safety system of the motor vehicle.

It is also advantageous to activate the acute indication as a function of safety-relevant parameters of a vehicle dynamics control system or also of a collision avoidance system. These types of safety systems are designed to recognize various types of risk situations, and to activate a risk status when a risk situation is recognized.

The invention will be described below in greater detail in the following description of exemplary embodiments with reference to the accompanying drawings.

### BRIEF DESCRIPTION OF THE DRAWINGS

FIG. 1 shows a motor vehicle for carrying out the method according to the invention,

FIG. 2 shows a flow chart for a stop function of a stop-start system,

FIG. 3 shows a flow chart for a risk status function, and

FIG. 4 shows a flow chart for a safety function.

### DESCRIPTION OF EXEMPLARY EMBODIMENTS

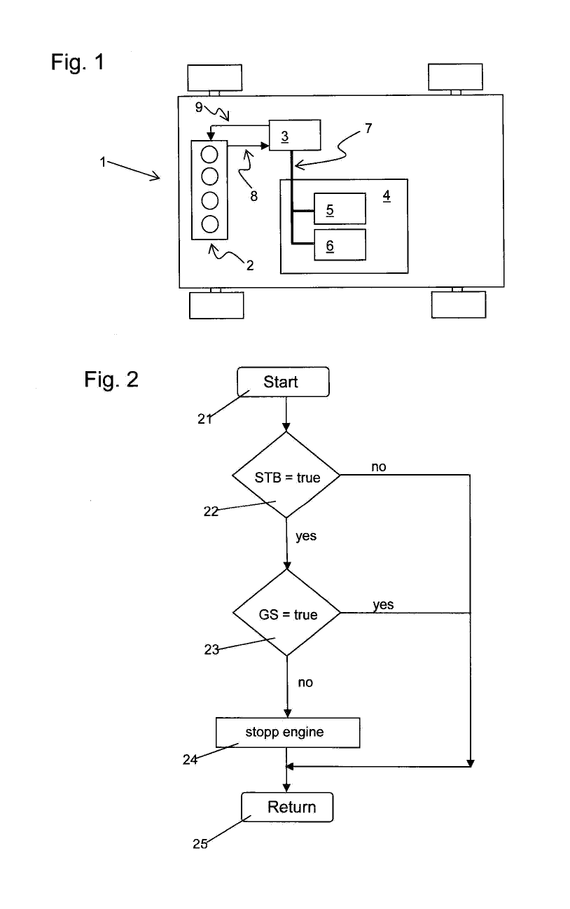

FIG. 1 shows a motor vehicle 1 for carrying out the method according to the invention. The motor vehicle 1 has an internal combustion engine 2, an engine control unit 3 for controlling and regulating the internal combustion engine 2 via control lines 9 and sensor lines 8, and a safety system 4. The safety system 4 has a vehicle dynamics control unit 5 and an anti-collision control unit 6 which are interconnected via a data bus system for purposes of data exchange. The safety system 4 is connected to the engine control unit 3 via the data bus system 7. The engine control unit 3 is connected to further control units, not illustrated, via the data bus system 7. The engine control unit 3 has a stop-start system, not illustrated in greater detail, by means of which the internal combustion engine 2 is automatically stopped and automatically started. The stop-start system of the engine control unit 3 receives safety parameters from the safety system 4 via the data bus system 7, the safety parameters being used for a function of the stop-start system.

FIG. 2 shows a flow chart for an engine stop function of the stop-start system. The engine stop function for automatically stopping the internal combustion engine 2 begins with a start step 21. The start step 21 includes preconditions, not illustrated, which must be met in order for the engine stop function to run properly. After the preconditions have been met, a stop condition 22 is checked. The stop condition 22 includes checking of multiple stop subconditions STB which must be met in order for an automatic stop of the internal combustion engine 2 to take place. When the stop condition 22 is met, a check is made as to whether a stop prevention condition 23 is met. The stop prevention condition 23 includes the checking of a risk status GS. If the risk status GS is not activated, a stop of the internal combustion engine 2 takes place in a stop command step

If the stop condition 22 is not met, a stop of the internal combustion engine 2 does not take place, and the engine stop function begins anew with the start step 21 after running through the return step 25. If the stop prevention condition 23 is met, a stop of the internal combustion engine 2 likewise does not take place, and a return is made to the start step 21.

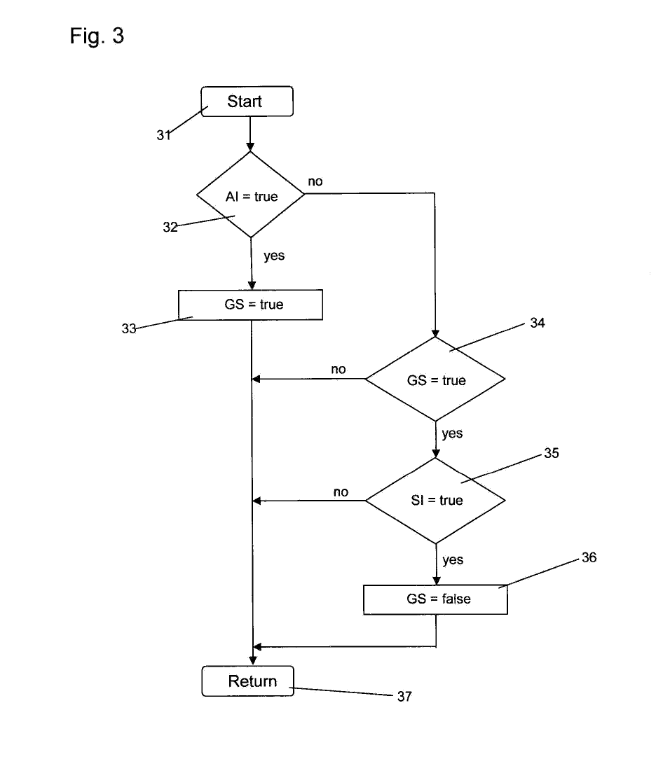

FIG. 3 shows a flow chart for a risk status function. The risk status function for assessing the risk status GS begins with a start step 31. The start step 31 includes further preconditions, not illustrated, which must be met in order for the risk status function to run properly. After the further preconditions have been met, an acute checking step 32 takes place. The acute checking step 32 includes a check of an acute indication AI. The acute indication AI is active when a risk is present. If the acute indication AI is active, this is followed by a risk display 33 in which the risk status GS is activated. After the risk status GS is activated, a return step 37 to the start step 31 takes place.

If a nonactive acute indication AI is identified in the acute checking step 32, the next operation is a risk status check 34 as to whether the risk status GS has been activated from a prior run of the risk status function. If the risk status GS has not been activated, the return step 37 is carried out. If the risk status GS has been activated, a safety status check 35 is carried out. In the safety status check 35 a check is made as to whether a safety indication SI is activated. If the safety indication SI is activated, the risk status GS is deactivated in an risk absence display 36, followed by the return step 37. If it is determined in the safety status check 35 that the safety indication SI is not activated, the risk status GS remains activated, and the return step 37 is carried out for rerunning the risk status function.

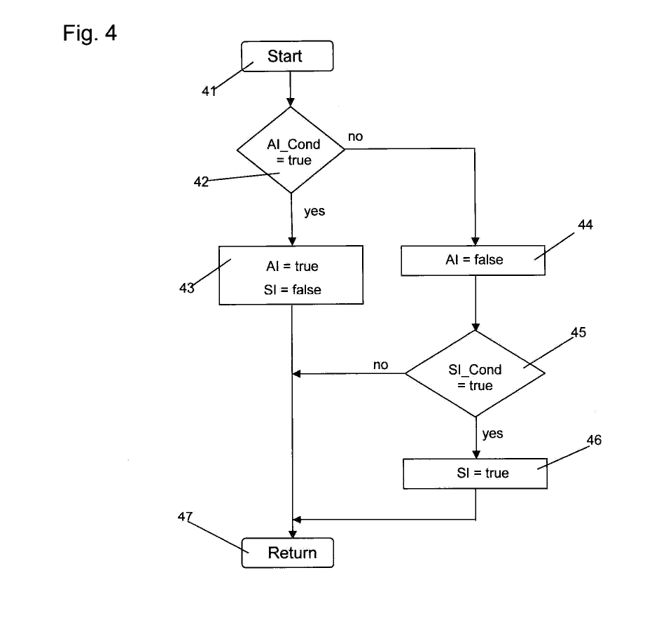

FIG. 4 shows a flow chart for a safety function. A start step 41 of the safety function includes preconditions, not illustrated, which must be met in order for the safety function to run properly. After the preconditions have been met, an acute condition step 42 takes place. In the acute condition step 42 a check is made via an acute condition AI_Cond for the presence of a type of risk. If the acute condition AI_Cond has been met, the acute indication AI is activated in an acute display 43, and at the same time the safety indication SI is deactivated. A return step 47 subsequently takes place for rerunning the safety function. If the acute condition AI_Cond has not been met, a deactivation 44 of the acute indication AI takes place. After the deactivation 41 of the acute indication AI, a safety condition step 45 takes place in which a safety condition SI_Cond is checked. If the safety condition SI_Cond is met, the safety indication SI is activated in a safety display 46.

An acute indication AI, an acute condition AI_Cond, and a safety condition SI_Cond are associated with each type of risk. Several types of risk and their acute conditions AI_Cond and safety conditions SI_Cond are listed below by way of example:
The type of risk is an overacceleration, and the associated acute indication AI is an acceleration indication; in this case the acute condition AI_Cond is met when a vehicle acceleration in one direction is greater than a first acceleration limit value; in this case the safety condition SI_Cond is met when the vehicle acceleration is less than a second acceleration limit value, and when a specified period of time has elapsed after the deactivation 44 of the acceleration indication; the second acceleration limit value is less than the first acceleration limit value;
Alternatively, the type of risk is a transverse acceleration, and the associated acute indication AI is a transverse acceleration indication; in this case the acute condition AI_Cond is met when a vehicle transverse acceleration is greater than a first transverse acceleration limit value; in this case the safety condition SI_Cond is met when the vehicle transverse acceleration is less than a second transverse acceleration limit value, and when a specified period of time has elapsed after the deactivation 44 of the transverse acceleration indication; the second transverse acceleration limit value is less than the first transverse acceleration limit value;
Alternatively, the type of risk is an oversteering or understeering of the motor vehicle 1, and the associated acute indication AI is a control indication; in this case the acute condition AI_Cond is met when an oversteering or understeering of the motor vehicle 1 has been recognized; in this case the safety condition SI_Cond is met when the oversteering or understeering of the motor vehicle is no longer present, and when a specified period of time has elapsed after the deactivation 44 of the control indication;
Alternatively, the type of risk is an evasive maneuver of the motor vehicle 1, and the associated acute indication AI is a steering indication; in this case the acute condition AI_Cond is met when a steering speed of the motor vehicle 1 is greater than a steering speed limit value, and a vehicle speed is greater than a vehicle speed limit value; in this case the safety condition SI_Cond is met when the steering speed of the motor vehicle 1 is less than the steering speed limit value, and the vehicle speed is less than the vehicle speed limit value;
Alternatively, the type of risk is a first collision risk, and the associated acute indication AI is a target braking indication; in this case the acute condition AI_Cond is met when target braking is carried out by a safety system of the motor vehicle 1; in this case the safety condition SI_Cond is met when the target braking has concluded, and when a specified period of time has elapsed after the deactivation 44 of the target braking indication;
Alternatively, the type of risk is a second collision risk, and the associated acute indication AI is an emergency braking indication; in this case the acute condition AI_Cond is met when carrying out of emergency braking is recognized by a safety system of the motor vehicle 1; in this case the safety condition SI_Cond is met when the emergency braking has concluded, and when a specified period of time has elapsed after the deactivation 44 of the emergency braking indication;
Alternatively, the type of risk is a third collision risk, and the associated acute indication AI is a collision indication; in this case the acute condition AI_Cond is met when a collision risk, in particular a lateral collision risk, is recognized by a safety system of the motor vehicle 1, for example via associated radar sensors; in this case the safety condition SI_Cond is met when the collision risk has passed, and when a specified period of time has elapsed after the deactivation 44 of the collision indication.

### LISTING OF REFERENCE NUMERALS

1 Motor vehicle
2 Internal combustion engine
3 Engine control unit
4 Safety system
5 Vehicle dynamics control unit
6 Anti-collision control unit
7 Data bus system
8 Sensor lines
9 Control lines
21 Start step of the engine stop function
22 Stop condition
23 Stop prevention condition
24 Stop command step
25 Return step of the engine stop function
31 Start step of the risk status function
32 Acute checking step
33 Risk display
34 Risk status check
35 Safety status check
36 Risk absence display
37 Return step of the risk status function
40 Sequence plan of the acute status function
41 Start step of the safety function
42 Acute condition step
43 Acute display
44 Acute deactivation
45 Safety condition step
46 Safety display
47 Return step of the safety function
STB Stop subconditions
GS Risk status
AI Acute indication
SI Safety indication
AI_Cond Acute condition
SI_Cond Safety condition

What is claimed is:

1. A method for automatically stopping an internal combustion engine (2) of a motor vehicle (1), when certain stop conditions (22) are met, said method comprising the steps of:
preventing an automatic stop of the internal combustion engine (2) when a stop prevention condition (23) is met,
the stop prevention condition (23) being met when a risk status (GS) is active and the risk status (GS) is activated when an acute indication (AI) is present,
after the acute indication (AI) has ended, keeping the risk status (GS) activated until a safety indication (SI) is present, so that, due to the internal combustion engine (2) remaining switched on, maneuverability of the motor vehicle (1) is maintained at least until the safety indication (SI) is present,
the acute indication (AI) being an acceleration indication (BI) or an emergency braking indication,
the acceleration indication (BI) being activated under the minimum prerequisite that a vehicle acceleration in one direction is greater than a first acceleration limit value, and the safety indication (SI) being activated under the minimum prerequisite that at least the magnitude of the vehicle acceleration is less than a second acceleration limit value, the second acceleration limit value being less than, or equal to, the first acceleration limit value, and
the emergency braking indication being activated under the minimum prerequisite that one of full braking and automatic braking is carried out.

2. The method according to claim 1, wherein the safety indication (SI) is present under the minimum prerequisite that the acute indication (AI) has ended, and a predetermined period of time has subsequently elapsed.

3. The method according to claim 1, wherein the safety indication (SI) is present under the minimum prerequisite that the acute indication (AI) has ended and the motor vehicle (1) has subsequently covered a specified distance,.

4. The method according to claim 1, wherein the acute indication (AI) is a transverse acceleration indication, the transverse acceleration indication being activated under the minimum prerequisite that a magnitude of a vehicle transverse acceleration is greater than a first transverse acceleration limit value, and the safety indication (SI) is activated under the minimum prerequisite that the magnitude of the vehicle transverse acceleration is less than a second transverse acceleration limit value, the second transverse acceleration limit value being less than or equal to the transverse acceleration limit value.

5. The method according to claim 1, wherein the acute indication (AI) is a control indication, the control indication being activated under the minimum prerequisite that an understeering or an oversteering of the motor vehicle (1) has been recognized, and the safety indication (SI) being activated under the minimum prerequisite that no understeering and no oversteering of the motor vehicle is (1) recognized for a predetermined period of time and/or a predetermined distance.

6. The method according to claim 1, wherein the acute indication (AI) is a steering indication, the, steering indication being activated under the minimum prerequisite that a rapid steering movement at a high speed has been recognized, and the safety indication (SI) is activated under the minimum prerequisite that no rapid steering movement is recognized for a specified period of time.

7. The method according to claim 1, wherein the acute indication (AI) is a target braking indication, the target braking indication being activated under the minimum prerequisite that radar-assisted target braking is carried out.

8. The method according to claim 1, wherein the acute indication (AI) is a collision indication, the collision indication being activated under the minimum prerequisite that a collision risk is recognized.

9. The method according to claim 1, wherein the acute indication (AI) is a function of parameters of a vehicle dynamics control system and/or of a collision avoidance system.
